(19) United States
(12) Patent Application Publication
(10) Pub. No.: US 2023/0100437 A1
(43) Pub. Date: Mar. 30, 2023

(54) IMAGE RECALL SYSTEM

(71) Applicant: Toshiba Global Commerce Solutions Holdings Corporation, Tokyo (JP)

(72) Inventors: Susan W. BROSNAN, Raleigh, NC (US); Jessica SNEAD, Cary, NC (US); Patricia S. HOGAN, Raleigh, NC (US); Daniel R. GOINS, Wake Forest, NC (US)

(21) Appl. No.: 17/488,927

(22) Filed: Sep. 29, 2021

(51) Int. Cl. G06Q 20/20; G06N 20/00; G06Q 30/06

(52) U.S. Cl. CPC G06Q 20/20; G06N 20/00; G06Q 30/0601

(57) ABSTRACT

A method includes receiving a first image of an item captured by a first camera when the item is purchased and linking the first image to a transaction component corresponding to the purchase of the item. The method also includes determining that the first image is linked to the transaction component and, in response to a request from a user device to display the item and in response to determining that the first image is linked to the transaction component, communicating the first image to the user device.

### BACKGROUND

Customers in stores (e.g., grocery stores) may often desire to purchase items that the customers previously purchased but encounter difficulty remembering the name or appearance of those items. In many instances, these customers will purchase items and discover later that the items were not what the customers wanted. The customers then return the items or throw the items away. As a result, significant computing resources (e.g., processor and memory resources) are unnecessarily used to process the purchase and return. Additionally, significant food waste occurs if the items are not returned.

### BRIEF DESCRIPTION OF THE DRAWINGS

FIG. 1 illustrates an example system.

FIG. 2 illustrates an example point of sale system in the system of FIG. 1.

FIG. 3 illustrates an example computing system that interfaces with the system of FIG. 1.

FIG. 4 illustrates an example computing system that interfaces with the system of FIG. 1.

FIG. 5A illustrates an example computing system that interfaces with the system of FIG. 1.

FIG. 5B illustrates an example image received by the computing system of FIG. 5A.

FIG. 6 illustrates an example computing system that interfaces with the system of FIG. 1.

FIG. 7A illustrates an example user device in the system of FIG. 1.

FIG. 7B illustrates an example user device in the system of FIG. 1.

FIG. 8 illustrates example user devices that interface with the computing system of FIGS. 3-6.

FIG. 9 is a flowchart of an example method performed in the computing system of FIG. 3-6.

### DETAILED DESCRIPTION

The present disclosure describes a computing system that interfaces with point of sale (POS) systems to provide a user with images of items that the user previously purchased. When the user purchases items, the computing system receives images of the items taken by cameras positioned near or around a POS system. The computing system selects images of items (e.g., by applying a machine learning model) and links the selected images to a receipt for the purchase. In one example, the computing system links the images to the receipt using a specific data structure for the receipt. At a later time, the user submits a request to retrieve the image for a previously purchased item. The computing system responds by retrieving the image of the item that was taken when the user purchased the item and sending that image to the user.

Advantages of the Computing System

The computing system provides the user with images that were taken when the user purchased an item to remind the user of what the user previously purchased. Thus, the computing system reduces the amount of computing resources used to process purchases and returns of undesired items, in certain embodiments. This reduction in computing resources used may also result in a reduction of electrical power used, thereby conserving energy. Additionally, the computing system reduces the amount of food waste caused by the purchase of undesired items, in some embodiments.

Additionally, in some embodiments, the computing system uses a machine learning model or a camera prioritization to reduce the amount of computing resources used to select between or amongst multiple images of an item for linking to a receipt. For example, the computing system avoids using computing resources to analyze the images by using the camera prioritization to select images based on the cameras that took the images rather than on the characteristics or quality of the images. As another example, the computing system reduces computing resources used to analyze the images by using the machine learning model to apply specific algorithms to predict the identity of items shown in the images and to determine confidence levels for those predictions. The computing system then selects an image based on the predicted identities or the confidence levels instead of performing a pixel-by-pixel analysis of the images, which is a resource intensive process.

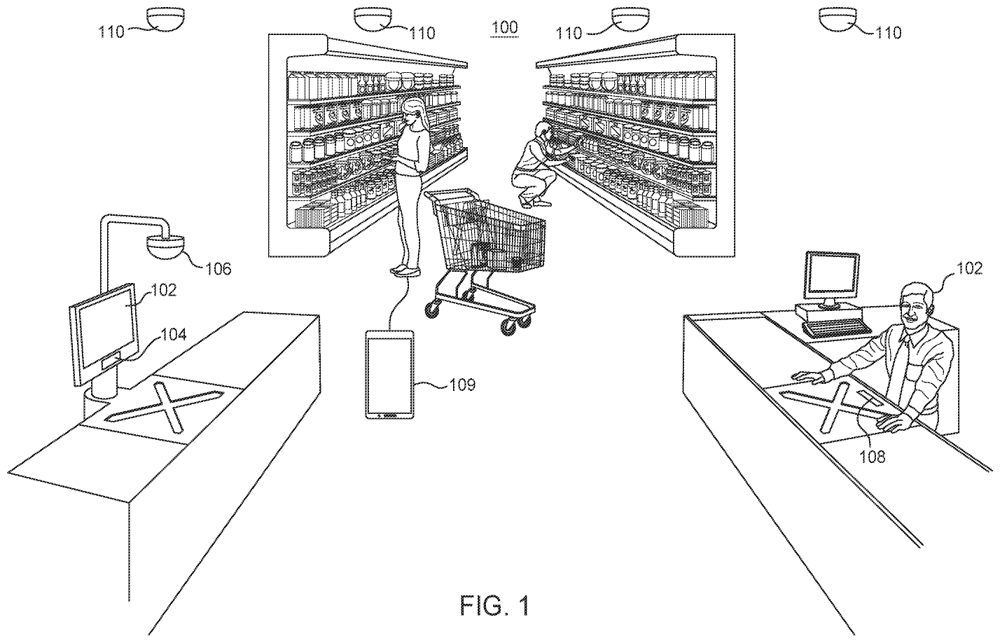

FIG. 1 illustrates an example system 100. As seen in FIG. 1, the system 100 may be a store in which customers can purchase items. The system 100 includes one or more POS systems 102 and cameras 104, 106, 108 and 110. When a customer purchases an item, an image of the item is captured and linked to the customer's receipt. This image may be subsequently retrieved to remind the customer of the previously purchased item. In one example, the customer is reminded of previous purchases and may avoid purchasing and returning an undesired item, which conserves computing resources, in certain embodiments.

The system 100 includes one or more POS systems 102. A customer may approach a POS system 102 and use the POS system 102 to scan items that the customer desires to purchase. In one example, the POS system 102 records the scanned item and calculates the total price. The POS system 102 may be a self-checkout station or a checkout station with an employee, who assists in the checkout process.

In certain embodiments, a user device 109 may serve as a POS system to scan and purchase items. For example, a customer may use a camera of the device 109 to scan and purchase items as the customer walks through the store. The device 109 may be a computer, a laptop, a wireless or cellular telephone, an electronic notebook, a personal digital assistant, a tablet, or any other device capable of receiving, processing, storing, or communicating information. The device 109 may be a wearable device such as a virtual reality or augmented reality headset, a smart watch, or smart glasses. The device 109 may also include a user interface, such as a display, a microphone, keypad, or other appropriate terminal equipment usable by the user. The device 109 may include a hardware processor, memory, or circuitry configured to perform any of the functions or actions of the device 109 described herein. For example, a software application designed using software code may be stored in the memory and executed by the processor to perform the functions of the device 109.

A set of cameras may be positioned throughout the system 100. For example, a self-checkout station may include a camera 104 embedded in the self-checkout station. Additionally, or alternatively, a camera 106 may be coupled to the self-checkout station and positioned above the self-checkout station. The camera 104 and the camera 106 may capture an image of an item when the item is scanned at the self-checkout station. As seen in FIG. 1, the camera 104 may be positioned near a scanning location on the checkout station, and the camera 106 may be positioned above the scanning location. Each of the cameras 104 and 106 may capture an image, or multiple images, of an item when scanned at the self-checkout station. The multiple images may be captured from different perspectives based on the positioning of the camera 104 or the camera 106. The cameras 104 and 106 are shown as examples. Any number of cameras may be positioned on or near the self-checkout station to capture any number of images of a purchased item.

A camera 108 may be positioned at the conventional checkout station. The camera 108 may also capture an image of an item when the item is scanned at the checkout station. Furthermore, cameras 110 may be positioned on the ceiling of the store. The cameras 110 may be security cameras that monitor the activity within the store. The security cameras 110 may capture an image of an item when the item is scanned at the self-checkout station or the conventional checkout station. The cameras 108 and 110 are shown as examples. Any number of cameras may be positioned on or near the checkout station or the ceiling to capture any number of images of a purchased item.

In some embodiments, a customer may use the user device 109 to capture an image of an item when purchasing the item. For example, the user device 109 may include an application that uses a camera of the device 109 to scan an item when the customer desires to purchase the item. The user device 109 records the item and calculates the price.

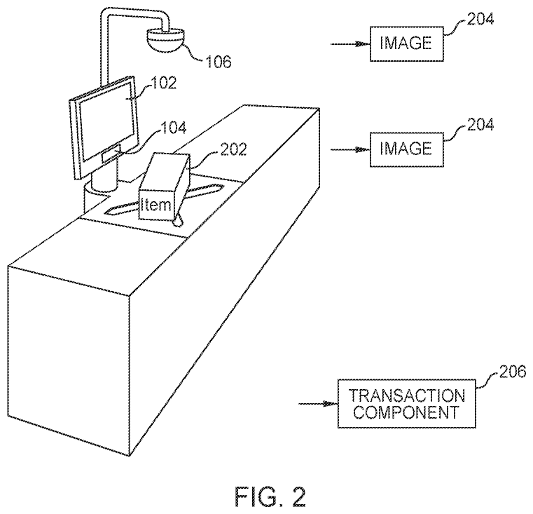

FIG. 2 illustrates an example POS system 102 in the system 100 of FIG. 1. As seen in FIG. 2, an item 202 is scanned using the POS system 102. When the item 202 is scanned, one or more cameras capture an image of the item 202. In the example of FIG. 2, a camera 104 captures an image 204 of the item 202 when the item 202 is scanned by the POS system 102. Additionally, a camera 106 captures another image 204 of the item 202 when the item 202 is scanned. Generally, any suitable number of cameras in the system 100 may capture an image 204 of the item 202 when the item 202 is scanned at a POS system 102. These images 204 may be captured from different viewpoints depending on the positioning of the cameras.

After the purchase is complete, the POS system 102 generates a transaction component 206 indicating the purchase. In some embodiments, the transaction component 206 is a digital receipt that a customer may access using the user device 109. Additionally, the POS system 102 may generate a physical copy of the transaction component 206, such as a paper receipt that the customer can take. The transaction component 206 may be a receipt, a transaction order, a purchase order, a product sales inventory document, or any other document associated with the purchase.

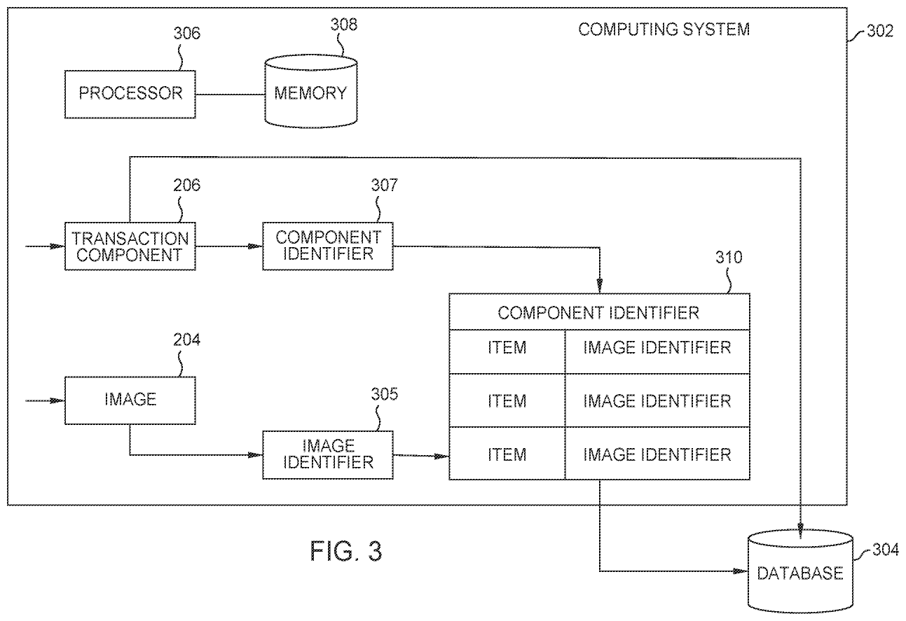

FIG. 3 illustrates an example computing system 302 that interfaces with the system 100 of FIG. 1. The computing system 302 links one or more images 204 to a transaction component 206. As seen in FIG. 3, the computing system 302 includes a processor 306 and a memory 308, which perform the actions and functions of the computing system 302 described herein. In certain embodiments, the computing system 302 includes one or more computing devices (e.g., tablets, laptops, desktop computers, or servers) implemented by a store or an owner of one or more stores. The computing system 302 interfaces with one or more POS systems 102 or user devices 109 to link and retrieve images of previously purchased items.

The processor 306 is any electronic circuitry, including, but not limited to one or a combination of microprocessors, microcontrollers, application specific integrated circuits (ASIC), application specific instruction set processor (ASIP), and/or state machines, that communicatively couples to memory 308 and controls the operation of the computing system 302. The processor 306 may be 8-bit, 16-bit, 32-bit, 64-bit or of any other suitable architecture. The processor 306 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 306 may include other hardware that operates software to control and process information. The processor 306 executes software stored on the memory 308 to perform any of the functions described herein. The processor 306 controls the operation and administration of the computing system 302 by processing information (e.g., information received from the devices 109, cameras 104, 106, 108, and 110, and memory 308). The processor 306 is not limited to a single processing device and may encompass multiple processing devices.

The memory 308 may store, either permanently or temporarily, data, operational software, or other information for the processor 306. The memory 308 may include any one or a combination of volatile or non-volatile local or remote devices suitable for storing information. For example, the memory 308 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 308, a disk, a CD, or a flash drive. In particular embodiments, the software may include an application executable by the processor 306 to perform one or more of the functions described herein.

The computing system 302 receives an image 204 from a POS system 102 or user device 109. As discussed previously and as shown in FIG. 2, the image 204 may be of an item 202 when the item 202 was scanned for purchase. The computing system 302 also receives a transaction component 206 indicating the purchase of the item 202. The computing system 302 links the image 204 to the transaction component 206.

The computing system 302 may link the image 204 to the transaction component 206 using identifiers for the image 204 and the transaction component 206. As seen in FIG. 3, the computing system 302 generates or determines an image identifier 305 for the image 204. The image identifier 305 may be a sequence of characters that identify the image 204. Additionally, the computing system 302 determines or generates a component identifier 307. The component identifier 307 may be a sequence of characters that identify the transaction component 206.

The computing system 302 then stores the image identifier 305 and the component identifier 307 in a data structure 310 specifically designed to link images 204 to the transaction component 206. For example, the data structure 310 may take the form of a table, array, or matrix. As seen in FIG. 3, the data structure 310 includes an entry for the component identifier 307. As such, the component identifier 307 identifies the data structure 310 as belonging to the transaction component 206. Additionally, the data structure 310 includes entries for purchased items shown in the transaction component 206. The items may be identified in the data structure 310 using the item names or sequences of alphanumeric characters. Additionally, for each item in the transaction component 206, the data structure 310 includes a corresponding image identifier 305 that identifies an image of the purchased item. The computing system 302 adds the image identifier 305 to the data structure 310 by adding the image identifier 305 into an entry corresponding to a purchased item shown in the transaction component 206. As a result, the data structure 310 links the image identifier 305 for an image 204 to an item shown in the transaction component 206. The computing system 302 then stores the data structure 310 and the image 204 into a database 304. The database 304 may be any suitable storage mechanism for storing and retrieving the data structure 310 and the image 204.

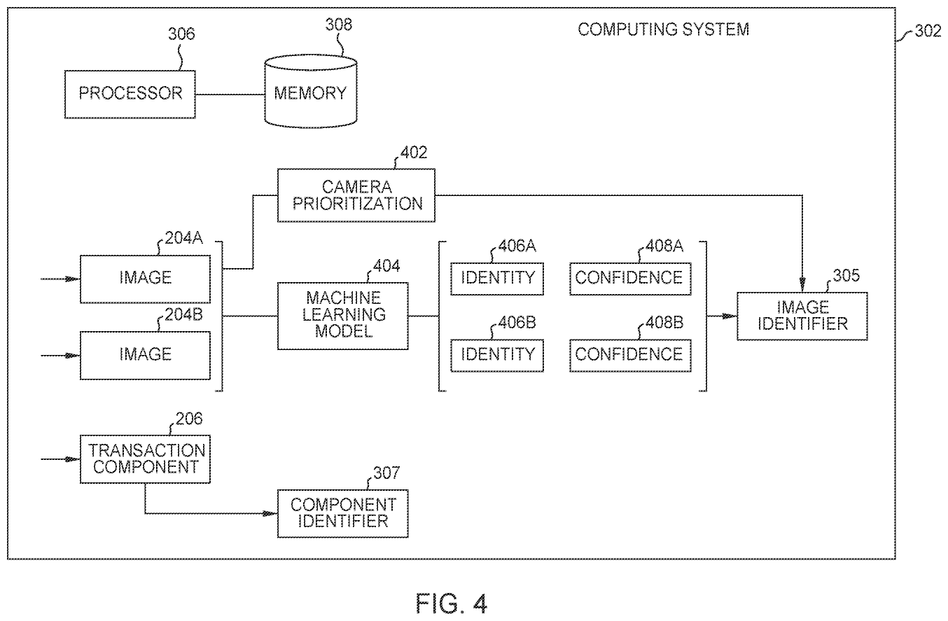

FIG. 4 illustrates the example computing system 302 that interfaces with the system 100 of FIG. 1. As seen in FIG. 4, the computing system 302 selects an image 204 to be linked to an item shown in a transaction component 206. The computing system 302 may use any suitable process for selecting the image 204.

The computing system 302 receives multiple images 204 of an item when the item is purchased. In the example of FIG. 4, the computing system 302 receives an image 204A and an image 204B. The image 204A and the image 204B may have been captured by different cameras positioned in the system 100. As a result, the images 204A and 204B show different perspectives of the item when the item was purchased. The computing system 302 may use any suitable process for determining which of the images 204A and 204B should be selected to link to an item shown in the transaction component 206.

For example, the computing system 302 may use a camera prioritization 402 to select between the images 204A and 204B. The camera prioritization 402 may include a ranking or ordering of the cameras in the system 100. Cameras with a higher priority should have their images selected to be linked to the transaction component 206. For example, a camera that is embedded in a POS system 102 may have a higher priority than a camera positioned on the ceiling. As another example, a camera on a user device may have higher priority than a camera embedded in a POS system. The computing system 302 may select the image 204 that is captured by a camera with the higher prioritization in the camera prioritization 402. After that image 204 is selected, the computing system 302 generates or determines an image identifier 305 for the selected image 204.

As another example, the computing system 302 may apply a machine learning model 404 to the images 204A and 204B to determine which image 204A or 204B should be selected for linking to the transaction component 206. The machine learning model 404 may be applied to identify an item shown in an image 204 based on the appearance of the item in the image 204. When the machine learning model 404 is applied to an image 204, the machine learning model 404 may predict the identity of an item shown in the image 204 along with a confidence level of that prediction. In the example of FIG. 4, the machine learning model 404 is applied to the images 204A and 204B. The machine learning model 404 predicts an identity 406A for an item shown in the image 204A with a confidence level 408A. Additionally, the machine learning model 404 predicts an identity 406B for an item shown in the image 204B with a confidence level 408B. The predicted identities 406A and 406B may be different from each other.

The computing system 302 may then select the image 204 based on the predicted identities 406 or the confidence levels 408. For example, the computing system 302 may compare the predicted identities 406 with the name of the item shown in the transaction component 206. The computing system 302 may select the image 204 for which the machine learning model 404 predicted an identity 406 that matches the item name in the transaction component 206. As another example, the computing system 302 may select the image 204 for which the machine learning model 404 made the prediction with the highest confidence level 408. In the example of FIG. 4, if the confidence level 408A is higher than the confidence level 408B, then the computing system 302 may select the image 204A for linking to the transaction component 206. In one example, the computing system 302 selects the image 204 and generates the image identifier 305 for the selected image 204. In another example, the computing system 302 determines the image identifier 305 for the selected image 204. The computing system 302 links the image identifier 305 to the transaction component 206 and stores the image 204 into a database, according to the process described using FIG. 3.

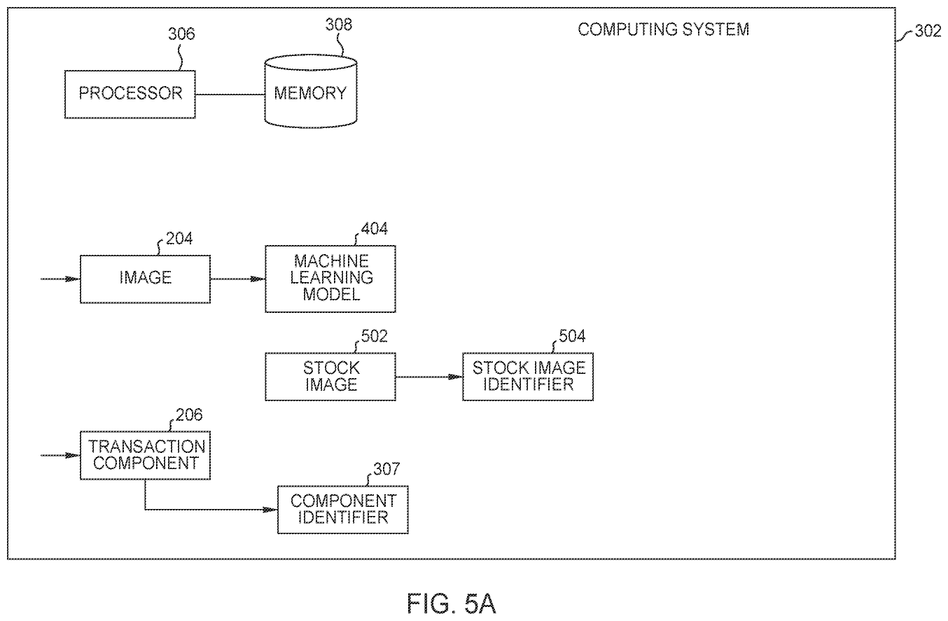

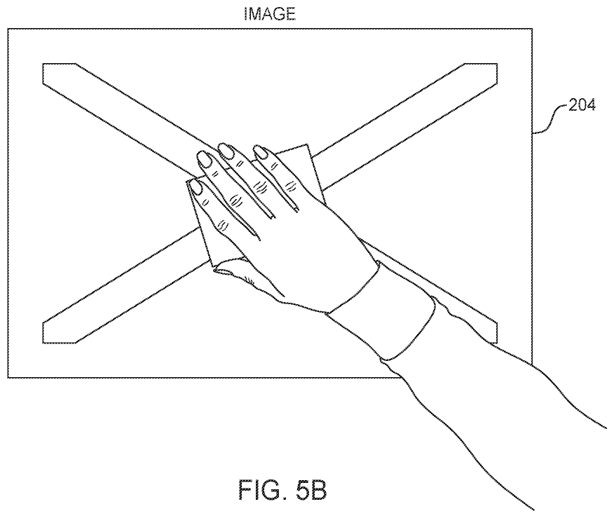

FIG. 5A illustrates an example computing system 302 that interfaces with the system 100 of FIG. 1. As seen in FIG. 5A, the computing system 302 links a default image to the transaction component 206 when the image 204 does not provide a clear picture of a purchased item.

The computing system 302 may apply the machine learning model 404 to the image 204 to predict the identity of an item shown in the image 204. The image 204 may not clearly depict the item. For example, the item in the image 204 may be obfuscated by a customer's hand, as seen in FIG. 5B. When the machine learning model 404 is applied to the image 204, the machine learning model 404 may predict an identity of the item with a low confidence level or the machine learning model 404 may be unable to predict the identity of the item based on the image 204. In response, the computing system 302 selects a stock image 502 for the item based on the name of the item shown in the transaction component 206. The stock image 502 may be a default image of the item that was previously generated. The stock image 502 may not be an accurate depiction of the item purchased by the customer.

In one example, the computing system 302 generates or determines a stock image identifier 504 for the stock image 502. The computing system 302 links the stock image identifier 504 to the transaction component 206 and stores the stock image 502 in the database 304, according to the process described using FIG. 3. As a result, the computing system 302 links an image to the transaction component 206 even though none of the captured images 204 show the item.

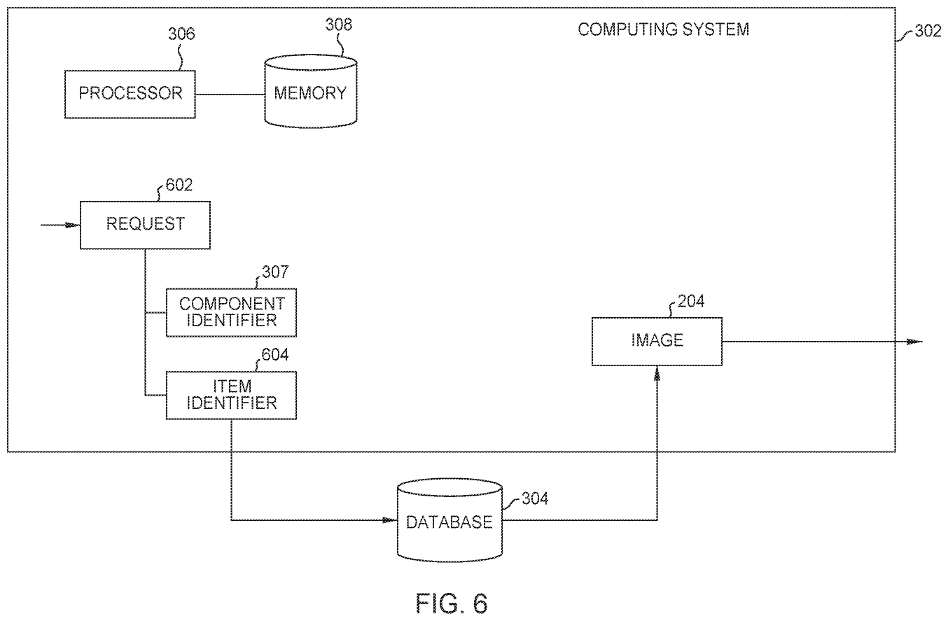

FIG. 6 illustrates an example computing system 302 that interfaces with the system 100 of FIG. 1. As seen in FIG. 6, the computing system 302 retrieves images 204 from the database 304 based on user requests.

The computing system 302 receives a request 602 for a particular item that was previously purchased. The request 602 may be communicated by a user device 109 (as shown in FIG. 1). As seen in FIG. 6, the request 602 may include an item identifier 604 and a component identifier 307. The request 602 may have been generated with these identifiers when a customer opened a receipt for a previous purchase on the user's device 109 and selected a particular item shown in the receipt. In response to that selection, the user device 109 generates the request 602 with a component identifier 307 for the receipt and an identifier 604 for the selected item. The user device 109 communicates the request 602 to the computing system 302.

The computing system 302 uses the component identifier 307 and the item identifier 604 to index into the database 304. The database 304 may retrieve the data structure 310 (as shown in FIG. 3) for the receipt identified by the receipt identifier 307. The database 304 determines from the data structure 310 an image identifier corresponding to the item identified by the item identifier 604. The computing system 302 retrieves from the database 304 the image 204 identified by the determined image identifier. The image 204 may be an image of the item selected by the user. The computing system 302 retrieves the image 204 and communicates the image 204 to the user device 109. When the user device 109 receives the image 204, the user device 109 presents the image 204 to show the user a picture of the selected item.

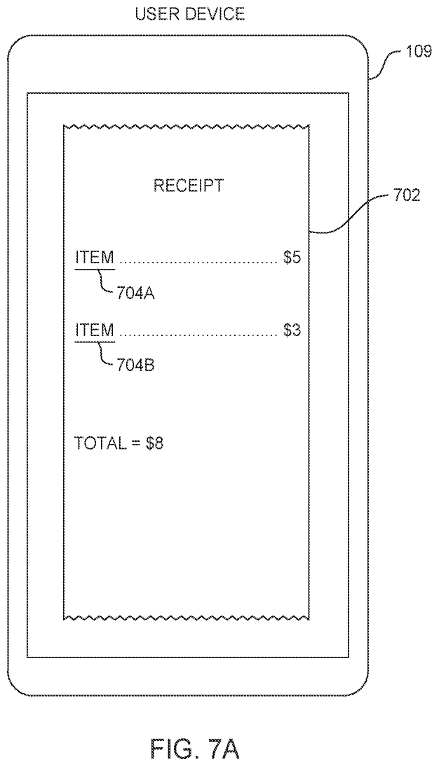

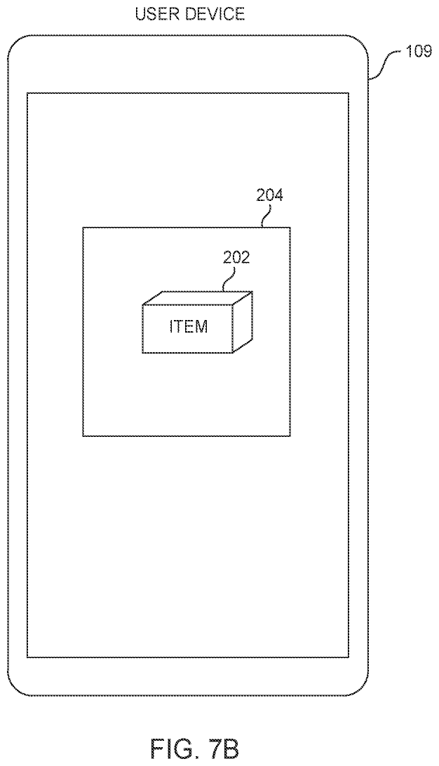

FIGS. 7A and 7B illustrate an example user device 109 in the system 100 of FIG. 1. The user device 109 may be used to select a previously purchased item and to see an image of the previously purchased item. As seen in FIG. 7A, the user device 109 displays a receipt 702 for a previous purchase. The receipt 702 includes identifications of an item 704A and an item 704B that were previously purchased. The receipt 702 also indicates the prices paid for the items 704A and 704B. A user may select one of the items 704A and 704B to retrieve an image of the item 704A and 704B taken when the item 704A or 704B was purchased.

For example, when the user selects the item 704A or 704B shown in the receipt 702, the user device 109 may generate and communicate a request to the computing system 302 to show the selected item 704A or 704B. The requests may include an identifier for the receipt 702 and an identifier for the selected item 704. The computing system 302 uses the receipt identifier and the item identifier to reference into a database 304. Using those identifiers, the database 304 retrieves an image 204 of the selected item 704. The computing system 302 communicates the image 204 to the user device 109. FIG. 7B shows the user device 109 displaying a retrieved image 204. As seen in FIG. 7B, the image 204 shows the previously purchased item 202. In this manner, the user device 109 retrieves and presents a picture of an item 202 that was previously purchased by a user in response to the user selecting an item 704 from the receipt 702.

In one example, a receipt 702 for a previous purchase may not clearly identify an item. In response, a customer may select the items 704 shown in the receipt 702 to retrieve images 204 of those items. When the customer sees the images 204, the customer may be reminded of the appearance of the item and then go purchase the desired item. As a result, this feature reduces waste of computing resources used to purchase and return undesired items. Moreover, this feature reduces food waste resulting from the purchase and discarding of undesired items.

As another example, a store associate may use this feature when the store associate is purchasing items on behalf of a customer. The customer may have provided the store associate a list of items that the customer desires to purchase. When the store associate is purchasing the items on the list, the store associate may discover that one or more of the items are out of stock. In response, the store associate may retrieve previous receipts 702 of the customer to see if there are substituted items that the customer prefers. The store associate may select the items 704 shown in the receipts 702 to see images of items 202 that the customer previously purchased. Based on these images 204, the store associate may determine a preferred substitute item, and purchase the preferred substitute item on behalf of the customer.

In both examples, a computing system 302 selects the images 204 for linking to the receipt 702 using a camera prioritization 402 or a machine learning model 404. Using the camera prioritization 402 avoids using computing resources to analyze the images 204. Specifically, the camera prioritization 402 allows the computing system 302 to select images 204 based on the cameras that took those images 204 rather than characteristics or the quality of those images 204. Using the machine learning model 404 to select the images 204 reduces computing resource used to analyze the images 204. Specifically, the machine learning model 404 may apply specific image analysis algorithms that efficiently predict the identities of items in those images 204 and that provide confidence levels for those predictions. As a result, applying the machine learning model 404 uses less computing resources than a pixel-by-pixel analysis of the images 204 and produces more accurate predictions.

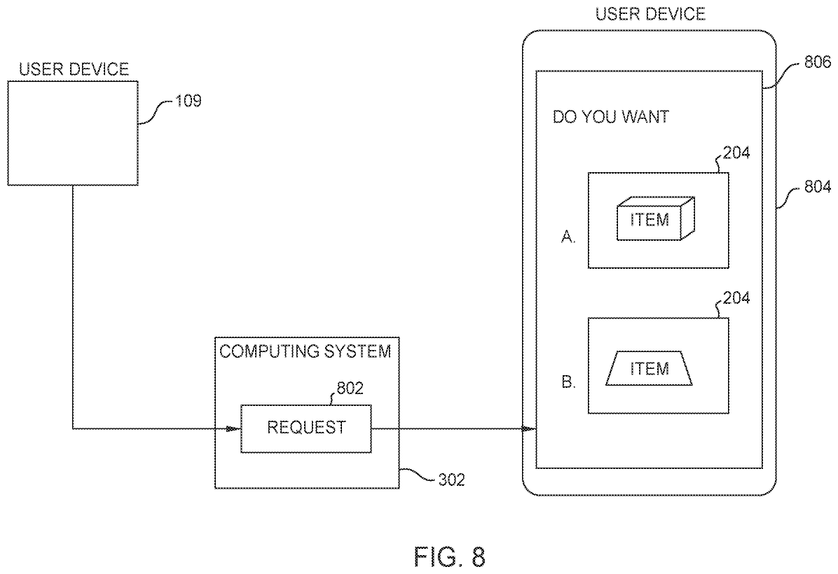

FIG. 8 illustrates example user devices that interface with the computing system 302 of FIGS. 3 through 6. As seen in FIG. 8, the computing system 302 retrieves images 204 of previously purchased items in response to requests from different user devices. As a result, the computing system 302 may provide polls or questionnaires to other user devices.

The computing system 302 receives a request 802 from the user device 109 to show one or more items. The request 802 may include a question or poll along with item identifiers. In response to the request 802, the computing system 302 retrieves images 204 corresponding to the item identifiers in the request 802 (e.g., by performing the process shown in FIG. 6). The computing system 302 generates and communicates a questionnaire or poll 806 to a different user device 804.

The user device 804 receives and displays the questionnaire or poll 806. The questionnaire or poll 806 includes a question asking which item a user prefers. The questionnaire or poll 806 includes the retrieved images 204 of the different item choices presented by the questionnaire or poll 806. A user of the user device 804 may select one or more of the images 204 in the questionnaire or poll 806 to indicate the user's desires or preferences. The user device 804 may communicate the selection to the computing system 302 or the user device 109. As a result, the user of the user device 109 is informed of the other's preferences or desires.

As another example, the questionnaire or poll 806 may ask a user whether a produce item was too ripe. The questionnaire or poll 806 may include an image of the produce item when purchased. The user may respond to the questionnaire or poll 806 to indicate a ripeness preference for the produce item.

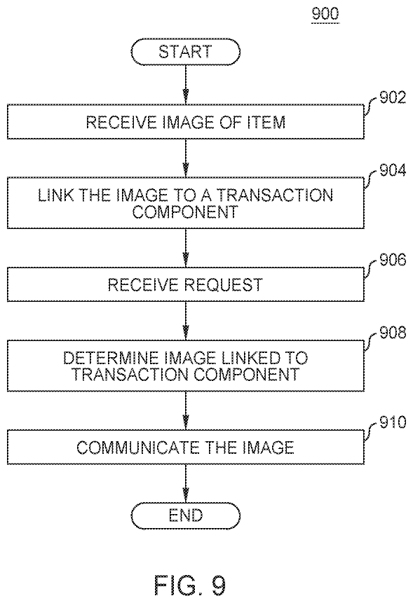

FIG. 9 is a flowchart of an example method 900 performed in the computing system 302 of FIGS. 3 through 6. In particular embodiments, by performing the method 900, the computing system 302 reduces waste of computing resources used to process the purchase and return of undesired items. Additionally, the computing system 302 reduces food waste caused by the purchase of undesired items.

In block 902, the computing system 302 receives an image 204 of an item 202. The image 204 may have been captured by a camera when the item 202 was purchased. For example, the camera may be embedded or coupled to a POS system 102 that scans the item 202. As another example, the camera may be embedded in a user device 109 used to scan the item 202 for purchase.

In block 904, the computing system 302 links the image 204 to a transaction component 206. The transaction component 206 may have been generated when a customer purchased the item 202. The transaction component 206 may identify the item 202. In certain embodiments, the computing system 302 links the image 204 to the transaction component 206 by generating or determining an image identifier 305 that identifies the item 202 and a component identifier 307 that identifies the transaction component 206. The computing system 302 then adds the image identifier 305 to a data structure 310 for the transaction component 206 or the component identifier 307. For example, the data structure 310 may include an entry for the component identifier 307 and another entry for the item in the transaction component 206. The computing system 302 may add the image identifier 305 to the data structure 310 such that the image identifier 305 corresponds to the item in the data structure 310.

Sometime later, in block 906, the computing system 302 receives a request 602 from a user device 109 to display the item 202. The user device 109 may have generated the request 602 in response to a user selection of the item 202 shown in a transaction component 206. For example, the request 602 may include a component identifier 307 that identifies the transaction component 206 and an item identifier 604 that identifies the selected item.

In block 908, the computing system 302 determines an image 204 linked to the transaction component 206. For example, the computing system 302 may identify the image 204 linked to the transaction component 206, based on the component identifier 307, and the item identifier 604 included in the request 602. The computing system 302 may use the component identifier 307 and item identifier 604 to index into the database 304. The database 304 may retrieve a data structure 310, based on the component identifier 307. The computing system 302 may retrieve from the data structure 310 an image identifier 305 corresponding to the item identifier 604 in the request 602. The computing system 302 may retrieve the image 204 from the database 304 that corresponds to the determined image identifier 305. In block 910, the computing system 302 communicates the image 204 to the user device 109. The user device 109 may display the image 204. In one example, the image 204 reminds a user of a previously purchased item. This reminder may help the user remember the item and to repurchase the correct item.

In summary, a computing system 302 interfaces with point of sale (POS) systems 102 to provide a user with images of items 202 that the user previously purchased. When the user purchases items 202, the computing system 302 receives images 204 of the items 202 taken by cameras 104, 106, 108, or 110 positioned near or around a POS system 102. The computing system 302 selects images 204 of items 202 (e.g., by applying a machine learning model 404) and then links the selected images 204 to a transaction component 206 for the purchase. The machine learning model 404 applies specific algorithms to analyze the images 204, which reduces computing resources used to analyze the images 204 for selection relative to a pixel-by-pixel analysis of the images 204. The computing system 302 may link the images 204 to the transaction component 206 using a specific data structure 310 for the transaction component 206. At a later time, the user may submit a request to retrieve the image 204 for a previously purchased item 202. The computing system 302 responds by retrieving the image 204 of the item 202 that was taken when the user purchased the item 202 and sending that image 204 to the user.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications or related data available in the cloud. For example, the images 204, receipts 206, and data structures 310 may be stored in a database 304 in the cloud. Doing so allows a user to access this information from any computing system attached to a network connected to the cloud (e.g., the Internet).

While the foregoing is directed to embodiments of the present disclosure, other and further embodiments of the present disclosure may be devised without departing from the basic scope thereof, and the scope thereof is determined by the claims that follow.

What is claimed is:

1. A method comprising:
receiving a first image of an item captured by a first camera when the item is purchased;
linking the first image to a transaction component corresponding to the purchase of the item;
determining that the first image is linked to the transaction component; and
in response to a request from a user device to display the item and in response to determining that the first image is linked to the transaction component, communicating the first image to the user device.

2. The method of claim 1, further comprising:
predicting, by applying a machine learning model to the first image, a first identity of the item;
receiving a second image of the item, wherein the second image is captured by a second camera when the item is purchased; and
predicting, by applying the machine learning model to the second image, a second identity of the item, wherein linking the first image to the transaction component is in response to determining that a first confidence level for the first identity meets a threshold and that a second confidence level for the second identity does not meet the threshold.

3. The method of claim 1, further comprising receiving a second image of the item, wherein the second image is captured by a second camera when the item is purchased, and wherein linking the first image to the transaction component is in response to determining that the first camera has a higher priority than the second camera.

4. The method of claim 1, further comprising:
receiving a second image of a second item, wherein the second image is captured by the first camera when the second item is purchased; and
in response to determining that the second item is obfuscated in the second image, linking a stock image of the second item rather than the second image to the transaction component.

5. The method of claim 1, further comprising, in response to a second request from the user device to display the item and in response to determining that the first image is linked to the transaction component, communicating a poll and the first image to a second user device, wherein the poll comprises the first image and a question concerning the item.

6. The method of claim 1, wherein linking the first image to the transaction component comprises adding an identifier to a data structure associated with the transaction component.

7. The method of claim 6, wherein the data structure comprises an entry and wherein the identifier is linked to the entry when the identifier is added to the data structure.

8. The method of claim 1, wherein the first camera is coupled to a point of sale (POS) system associated with the item.

9. The method of claim 1, wherein the first camera is coupled to the user device.

10. An apparatus comprising:
a memory; and
a hardware processor communicatively coupled to the memory, the hardware processor configured to:
receive a first image of an item captured by a first camera when the item is purchased;
link the first image to a transaction component corresponding to the purchase of the item;
determine that the first image is linked to the transaction component; and
in response to a request from a user device to display the item and in response to determining that the first image is linked to the transaction component, communicate the first image to the user device.

11. The apparatus of claim 10, the hardware processor further configured to:
predict, by applying a machine learning model to the first image, a first identity of the item;
receive a second image of the item, wherein the second image is captured by a second camera when the item is purchased; and
predict, by applying the machine learning model to the second image, a second identity of the item, wherein linking the first image to the transaction component is in response to determining that a first confidence level for the first identity meets a threshold and that a second confidence level for the second identity does not meet the threshold.

12. The apparatus of claim 10, the hardware processor further configured to receive a second image of the item, wherein the second image is captured by a second camera when the item is purchased, and wherein linking the first image to the transaction component is in response to determining that the first camera has a higher priority than the second camera.

13. The apparatus of claim 10, the hardware processor further configured to:
receive a second image of a second item, wherein the second image is captured by the first camera when the second item is purchased; and
in response to determining that the second item is obfuscated in the second image, link a stock image of the second item rather than the second image to the transaction component.

14. The apparatus of claim 10, the hardware processor further configured to, in response to a second request from the user device to display the item and in response to determining that the first image is linked to the transaction component, communicate a poll and the first image to a second user device, wherein the poll comprises the first image and a question concerning the item.

15. The apparatus of claim 10, wherein linking the first image to the transaction component comprises adding an identifier to a data structure associated with the transaction component.

16. The apparatus of claim 15, wherein the data structure comprises an entry and wherein the identifier is linked to the entry when the identifier is added to the data structure.

17. The apparatus of claim 10, wherein the first camera is coupled to a point of sale (POS) system associated with the item.

18. The apparatus of claim 10, wherein the first camera is coupled to the user device.

19. A system comprising:
a camera coupled to a point of sale (POS) system;
a computing system comprising a hardware processor configured to:
receive an image of an item captured by the camera when the item is scanned at the POS system;
link the image to a transaction component corresponding to the purchase of the item;
determine that the image is linked to the transaction component; and
in response to a request from a user device to display the item and in response to determining that the image is linked to the transaction component, communicate the image to the user device.

20. The system of claim 19, the hardware processor is further configured to, in response to a second request from the user device to display the item and in response to determining that the image is linked to the transaction component, communicating a poll and the image to a second user device, wherein the poll comprises the image and a question concerning the item.
